(19) United States
(12) Patent Application Publication
(10) Pub. No.: US 2026/0179595 A1
(43) Pub. Date: Jun. 25, 2026

(54) ELECTRONIC KEYBOARD MODULE

(71) Applicant: YA HORNG ELECTRONIC CO., LTD., TAINAN CITY (TW)

(72) Inventor: Chin-I HUANG, TAINAN CITY (TW)

(21) Appl. No.: 19/192,357

(22) Filed: Apr. 29, 2025

(30) Foreign Application Priority Data
Dec. 24, 2024 (TW) 113214163

(51) Int. Cl. G10H 1/34

(52) U.S. Cl. CPC G10H 1/344; G10H 2220/221; G10H 2220/271; G10H 2220/295; G10H 2220/525

(57) ABSTRACT

An electronic keyboard module includes a keyboard bracket, a keyboard, a conductive film and a force sensing resistor circuit board. The keyboard includes plural keys and key height-limited posts disposed on lower surfaces of the keys. The conductive film includes an insulation layer and plural conductive regions. The conductive regions are spaced apart from each other and disposed on the insulation layer, and the insulation layer is located between the key height-limited posts and the conductive regions. The force sensing resistor circuit board includes plural electrode units disposed under the conductive regions. The conductive film is located between the keyboard and the force sensing resistor circuit board. When at least one of the keys is under a pressed state, the key height-limited post presses the conductive film, so that the conductive region corresponding to the key touches and is electrically connected to the electrode unit.

### CROSS-REFERENCE TO RELATED APPLICATION

This application claims priority to Taiwan Application Serial Number 113214163, filed Dec. 24, 2024, which is herein incorporated by reference in its entirety.

### BACKGROUND

### Technical Field

The present disclosure relates to a keyboard module, and more particularly to an electronic keyboard module.

### Description of Related Art

As the processors' computing capabilities gradually increase, modern electronic musical instruments are capable of creating many effects and tones. Due to the difference in sound generation principles between electronic musical instruments and traditional musical instruments, some electronic musical instruments are able to produce effects and tones that cannot be produce d by traditional musical instruments. For example, the piezoelectric sensing technology may be applied to an electronic piano, enabling the electronic piano to produce an aftertouch effect that a conventional piano is unable to perform. However, the aftertouch function of the electronic keyboard is a mono aftertouch. In other words, all keys share a single aftertouch sensor (piezoresistive sensor). Therefore, even if multiple keys are pressed at the same time, only the aftertouch of one of the keys can be expressed, limiting the player in terms of tonal richness and emotional expression.

### SUMMARY

Therefore, the present disclosure provides an electronic keyboard module which is beneficial to improve the performance of the aftertouch effect.

In one aspect of the present disclosure, the electronic keyboard module is provided. The electronic keyboard module includes a keyboard bracket, a keyboard, a conductive film, and a force sensing resistor circuit board. The keyboard is located at the keyboard bracket, and the keyboard includes plural keys and plural key height-limited posts disposed one-to-one on the lower surfaces of the keys. The conductive film is located under the keyboard, and includes an insulation layer and plural conductive regions. The insulation layer is under the key height-limited posts, and the conductive regions are spaced apart from each other on the insulation layer. The conductive regions are disposed one-to-one under the keys, and the insulation layer is between the key height-limited posts and the conductive regions. The force sensing resistor circuit board is disposed under the conductive film, and the conductive film is between the keyboard and the force sensing resistor circuit board. The force sensing resistor circuit board includes plural electrode units disposed one-to-one under the conductive regions of the conductive film. When at least one of the keys is in a pressed state, the key height-limited posts under at least the one of the keys touch the conductive film, enabling the conductive regions corresponding to at least the one of the keys to touch and be electrically connected to the corresponding electrode units.

According to at least one example of the present disclosure, the electronic keyboard module further includes a touch-activated sound effect module. The touch-activated sound effect module is electrically connected to the force sensing resistor circuit board and configured to receive a piezoelectric signal from the force sensing resistor circuit board. When the conductive regions touch and are electrically connected to the corresponding electrode units, the force sensing resistor circuit board outputs the piezoelectric signal described above.

According to at least one example of the present disclosure, every one of the key height-limited posts has a plane, and the plane faces toward the conductive film, in which the area of the plane is greater than or equal to the area of every one of the conductive regions.

According to at least one example of the present disclosure, the thickness of the conductive regions is in a range of 0.01 mm to 0.04 mm.

According to at least one example of the present disclosure, the insulation layer is a polyester film.

According to at least one example of the present disclosure, the insulation layer includes plural positioning grooves disposed one-to-one between the electrode units and the keys. The opening of every one of the positioning grooves faces toward the force sensing resistor circuit board, and the conductive regions are disposed one-to-one on the bottom surface of every one of the positioning grooves.

According to at least one example of the present disclosure, the spacing between the opening and the bottom surface of the positioning grooves is greater than the thickness of the conductive regions.

According to at least one example of the present disclosure, the spacing between the opening and the bottom surface of the positioning grooves is in a range of 0.06 mm and 0.07 mm.

According to at least one example of the present disclosure, the electronic keyboard module further includes plural elastic bodies disposed one-to-one under the key height-limited posts, and between the key height-limited posts and the conductive film. When at least one of the keys is in the pressed state, the key height-limited posts under at least the one of the keys in the pressed state touch the conductive film through the elastic bodies, enabling the conductive regions corresponding to at least the one of the keys to touch and be electrically connected to the corresponding electrode units.

According to at least one example of the present disclosure, the pressed state are maintained from an initial time to a complete time, and the contact area of one of the elastic bodies and one of the electrode units is gradually increased.

According to at least one example of the present disclosure, every one of the elastic bodies has a plane, and the plane faces toward the conductive film. The area of the plane of the elastic bodies is greater than or equal to the area of every one of the conductive regions.

According to at least one example of the present disclosure, the electronic key board further includes a positioning elastic post disposed at intervals on the elastic bodies, and the height of the positioning elastic post is greater than the height of elastic bodies. The key height-limited posts touch the positioning elastic post in the pressed state.

In one aspect of the present disclosure, the electronic keyboard module is provided. The electronic keyboard module includes a keyboard bracket, a keyboard, a conductive film, and a force sensing resistor circuit board. The keyboard is located at the keyboard bracket, and the keyboard includes plural keys and plural key height-limited posts. Each of keys has one end connected to the keyboard bracket via a spring, and the other end extending out from the keyboard bracket. The key height-limited posts are disposed one-to-one on the lower surfaces of the keys. The conductive film is located under the keyboard, and includes an insulation layer and plural conductive regions. The insulation layer is under the key height-limited posts, and the conductive regions are spaced apart from each other on the insulation layer. The conductive regions are disposed one-to-one under the keys, and the insulation layer is between the key height-limited posts and the conductive regions. The force sensing resistor circuit board is disposed under the conductive film, and the conductive film is between the keyboard and the force sensing resistor circuit board. The force sensing resistor circuit board includes plural electrode units disposed one-to-one under the conductive regions of the conductive film. When at least one of the keys is in a pressed state, the key height-limited posts under at least the one of the keys touch the conductive film, enabling the conductive regions corresponding to at least the one of the keys to touch and be electrically connected to the corresponding electrode units.

According to at least one example of the present disclosure, the plane of the key height-limited posts is substantially aligned with a top of the conductive region of the conductive film when one of the keys is in the pressed state.

According to at least one example of the present disclosure, the electronic keyboard further includes plural elastic bodies, in which the plane of the elastic bodies is substantially aligned with the top of the conductive region of the conductive film when the one of the keys is in the pressed state.

Based on the above, since the conductive regions of the conductive film of the electronic keyboard are disposed one-to-one under the key height-limited posts, therefore, when the keys are in the pressed state, the keys may drive the key height-limited posts downward to be in contact with the conductive film, and push the conductive regions distributed in the conductive film toward the force sensing resistor circuit board, so that the conductive regions may be electrically connected to the electrode units which is on the force sensing resistor circuit board. Since one key corresponds to one conductive region and one electrode unit, the keys may respectively produce independent aftertouch effects to improve the expressive richness of playing. On the other hand, the areas of the key height-limited posts that are contact with the conductive regions through the elastic bodies are substantially the same. Therefore, the contact force between the conductive regions and the electrode units may be evenly distributed, thereby improving the stability of the aftertouch effect.

### BRIEF DESCRIPTION OF THE DRAWINGS

The implementation of this disclosure can be understood from the following detailed description and graphical review. It should be noted that the multiple features are not drawn to industry-standard proportions. In fact, the dimensions of the multiple features may be increased or decreased arbitrarily for the sake of clarity of discussion.

FIG. 1 illustrates a stereogram of an electronic keyboard module in accordance with an example of the present disclosure.

FIG. 2 illustrates a cross-sectional view taken along section C of the electronic keyboard module as shown in the example of FIG. 1.

FIG. 3 illustrates a partial exploded view of the electronic keyboard module in accordance with an example of the present disclosure.

FIG. 4 illustrates a partial stereogram of the conductive film of the electronic keyboard module in accordance with an example of the present disclosure.

FIG. 5 illustrates a stereogram of the force sensing resistor circuit board of the electronic keyboard module in accordance with an example of the present disclosure.

FIG. 6A illustrates a cross-sectional view taken along section C of the electronic keyboard module in the pressed state as shown in the example of FIG. 1.

FIG. 6B illustrates a schematic diagram of the change in contact area of the elastic bodies and the electrode units in accordance with at least one example of the present disclosure.

FIG. 7A illustrates a partial stereogram of the electronic keyboard module in accordance with an example of the present disclosure.

FIG. 7B illustrates a partial stereogram of the electronic keyboard module in accordance with an example of the present disclosure.

### DETAILED DESCRIPTION

The present disclosure is described in detail using the following examples. It should be noted that the following description of examples of the present disclosure is provided herein for illustrative purposes only, and is not intended to be exhaustive of all embodiments or to limit the specific embodiments of the present disclosure. For example, the description “a first feature is formed on a second feature” includes a variety of embodiments, which covers that the first feature is in direct contact with the second feature, and additional features are formed between the first feature and the second feature, so that the first feature and the second feature may not be in directly contact with each other. In addition, the same component symbols used in the drawings and the description will indicate the same or similar components as far as possible.

In the following text, the dimensions (e.g., length, width, thickness, and depth) of the components (e.g., layers, films, substrates, and areas, etc.) in the drawings are enlarged in varying proportions for the purpose of clearly presenting the technical features of the present disclosure. Accordingly, the illustrations and explanations of the following embodiments are not limited to the dimensions and shapes presented by the components in the drawings, but should cover, for example, dimensions, shapes, and deviations therefrom due to actual processes and/or tolerances. For example, the flat surfaces shown in the drawings may have rough and/or non-linear features, and the acute angles shown in the drawings may be rounded. Therefore, the components presented in the drawings of the present disclosure are mainly for illustrative purposes and are not intended to accurately depict the actual shape of the components, nor are they intended to limit the scope of the claims applied for the present disclosure.

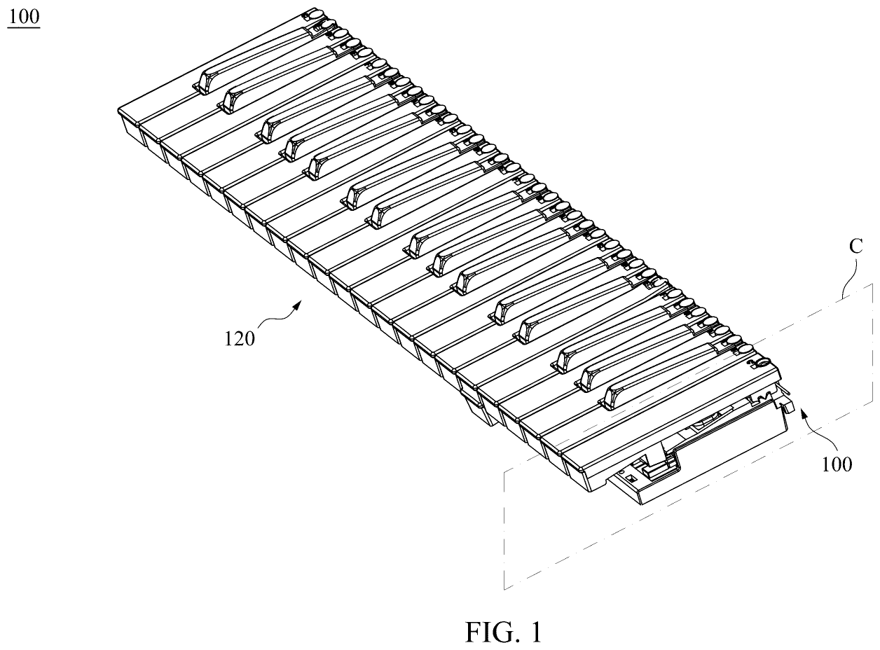

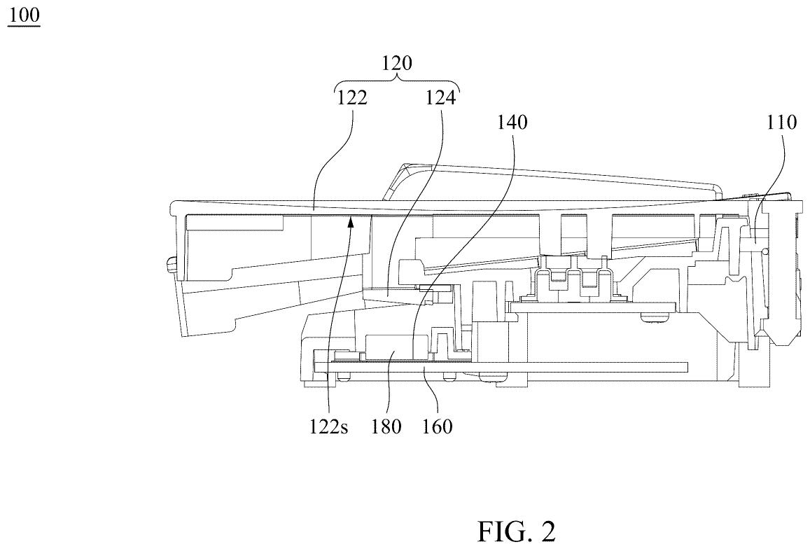

Jointly referring to FIGS. 1 and 2, FIG. 1 illustrates a stereogram of an electronic keyboard module 100 of at least one example of the present disclosure, and FIG. 2 illustrates a cross-sectional view taken along section C of the electronic keyboard module 100. The electronic keyboard module 100 includes the keyboard bracket 110, the keyboard 120, the conductive film 140, and the force sensing resistor circuit board 160. The keyboard 120 is located at the keyboard bracket 110, and the keyboard 120 includes the plural keys 122 and the plural key height-limited posts 124. The key height-limited posts 124 are disposed one-to-one on lower surfaces 122s of the keys 122, in other words, the key height-limited posts 124 are disposed under the keys 122, and one key height-limited post 124 corresponds to one key 122.

The keyboard 120 includes plural white keys and plural black keys. For example, a general electronic keyboard includes 49, 61 or 88 keys 122, and the configurations of the keys 122 may be similar to that of the general keys, therefore they may be not repeated herein. In the present example, one end of each key 122 is connected to the keyboard bracket 110 via a spring, and the other end of each key 122 extends out from the keyboard bracket 110.

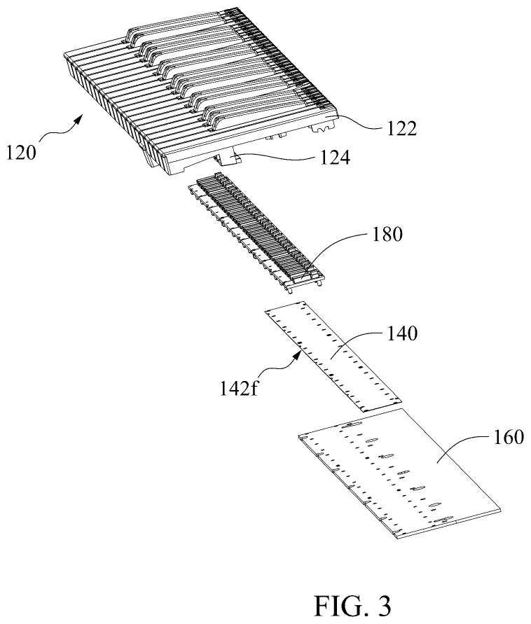

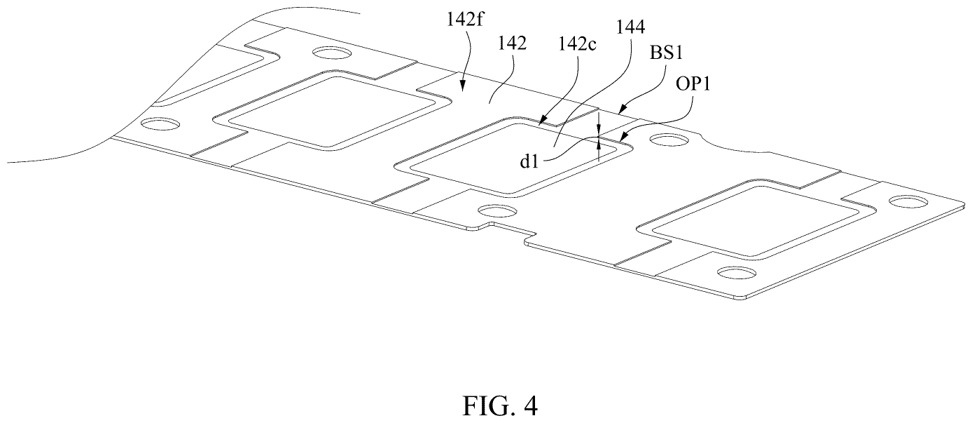

Jointly referring to FIGS. 3 and 4, FIG. 3 illustrates a partial exploded view of the electronic keyboard module 100 of at least one example of the present disclosure, in which the conductive film 140 is disposed under the keyboard 120, and FIG. 4 illustrates a partial stereogram of the conductive film 140 of at least one example of the present disclosure. The conductive film 140 is disposed under the key height-limited posts 124 of the keyboard 120, and the conductive film 140 includes the insulation layer 142 and the plural conductive regions 144. The insulation layer 142 is disposed under the key height-limited posts 124 of the keyboard 120, and the conductive regions 144 are spaced apart from each other on the insulation layer 142. In detail, the conductive regions 144 are disposed on the bottom surface 142f of the insulation layer 142, and the bottom surface 142f faces away from the keyboard 120 and toward the force sensing resistor circuit board 160. In particular, the conductive regions 144 are disposed one-to-one under the keys 122, and the insulation layer 142 is between the key height-limited posts 124 and the conductive regions 144.

Referring to FIG. 4, FIG. 4 illustrates a partial stereogram of the conductive film 140 of at least one example of the present disclosure. The insulation layer 142 of the conductive film 140 may be a polyester film, such as polyethylene terephthalate (PET), and the thickness of the insulation layer 142 is in the range of 0.06 mm to 0.07 mm. The material of the conductive regions 144 of the conductive film 140 may include, but is not limited to carbon, graphene, or slimier conductive materials, and the thickness of the conductive regions 144 is in the range of 0.01 mm to 0.04 mm. In specific, the conductive film 140 may be a layer of polyethylene terephthalate (e.g., Mylar) coated with a conductive material (e.g., toner), and the conductive material may be formed on the polyethylene terephthalate by a method such as screen printing.

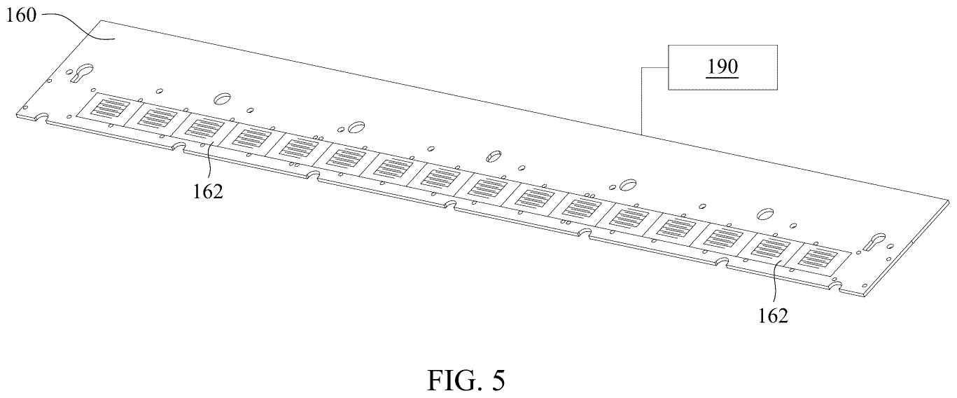

Jointly referring to FIGS. 2 and 3, the force sensing resistor circuit board 160 is disposed under the conductive film 140, and the conductive film 140 is between the keyboard 120 and the force sensing resistor circuit board 160. On the other hand, jointly refer to FIGS. 3 and 5, in which FIG. 5 illustrates a stereogram of the force sensing resistor circuit board 160. The force sensing resistor circuit board 160 includes the plural electrode units 162, and the electrode units 162 are disposed one-to-one under the conductive regions 144 of the conductive film 140.

Back to the FIG. 3, in detail, the electronic keyboard module 100 of the present example may include the plural elastic bodies 180. The elastic bodies 180 are disposed one-to-one under the key height-limited posts 124, and between the key height-limited posts 124 and the conductive film 140. When at least the one of the keys 122 is in the pressed state, the key height-limited posts 124 under the keys 122 in the pressed state touch the conductive film 140 by the elastic bodies 180, enabling the conductive regions 144 corresponding to the keys 122 (i.e., the keys 122 in the pressed state) to touch and be electrically connected to the corresponding electrode units 162.

In other words, every one of the keys 122 in the pressed state may respective apply a force (i.e., the downward force) to the insulation layer 142 of the conductive film 140 by the elastic bodies 180 under the keys 122, thereby enabling the conductive regions 144 under the insulation layer 142 to move (downward), and be in direct contact with the electrode units 162 of the force sensing resistor circuit board 160, achieving the electrical connection between the conductive regions 144 and the electrode units 162. The elastic bodies 180 may include, but are not limited to elastic materials, such as silica gel.

However, in other examples, the electronic keyboard module 100 may not include the elastic bodies 180. In other words, the key height-limited posts 124 under the keys 122 in the pressed state may be in direct contact with the conductive film 140, and apply a force (i.e., the downward force) to the insulation layer 142 of the conductive film 140, thereby enabling the conductive regions 144 under the insulation layer 142 to move downward, and be in direct contact with the force sensing resistor circuit board 160 to achieve the electrical connection between the conductive regions 144 and the force sensing resistor circuit board 160.

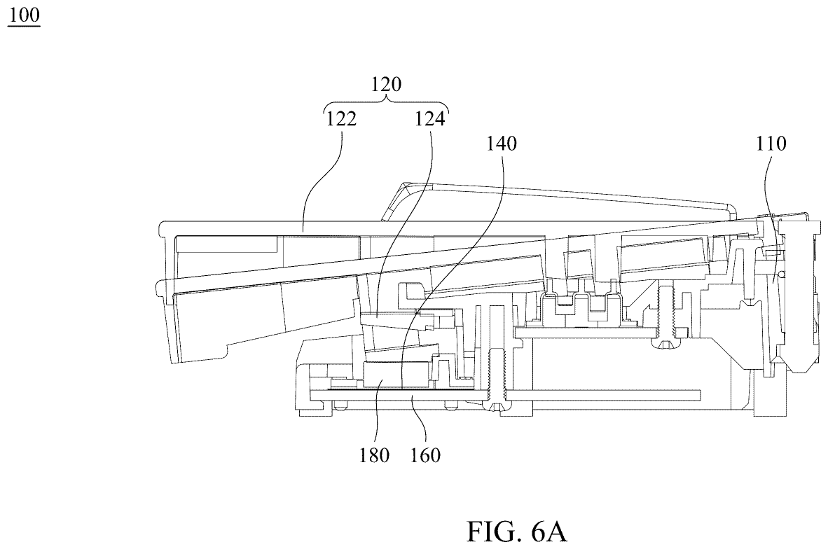

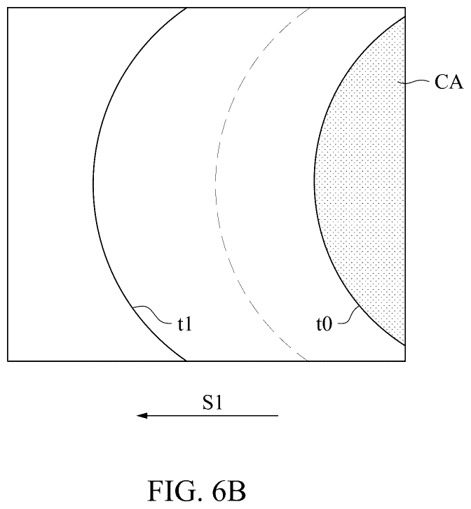

FIG. 6A illustrates a cross-sectional view of the keys 122 in the pressed state of at least one example of the present disclosure. When one of the keys 122 is in the pressed state, the key height-limited posts 124 under the one of the keys 122 may be in contact with the conductive film 140, enabling the conductive regions 144 corresponding to the one of key 122 to in contact with, and electrically connected to the corresponding electrode units 162. FIG. 6B illustrates a schematic diagram of the change in contact area of the elastic bodies 180 and the electrode units 162 of at least one example of the present disclosure. The pressed state described above are maintained from the initial time t0 to the complete time t1, and the contact area CA of one of the elastic bodies 180 and one of the electrode units 162 is gradually increased between the initial time to and the complete time t1.

In detail, when the keys 122 are applied to a downward force, the regions of the elastic bodies 180 adjacent to the keyboard bracket 110 may be first in contact with the electrode units 162. As the downward force increases, the contact range may gradually increase along the force direction S1. In other words, the maximum contact area CA may be less than or equal to the area of the plane 124p of the key height-limited posts 124 from the initial time t0 to the complete time t1.

In addition, as shown in FIG. 5, the electronic keyboard module 100 further includes the touch-activated sound effect module 190, and the touch-activated sound effect module 190 is electrically connected to the force sensing resistor circuit board 160. The touch-activated sound effect module 190 is configured to receive the piezoelectric signal from the force sensing resistor circuit board 160. In detail, when the conductive regions 144 is in contact with, and electrically connected to the corresponding electrode units 162, the force sensing resistor circuit board 160 outputs a piezoelectric signal. The piezoelectric signal may be transmitted to the touch-activated sound effect module 190. After the touch-activated sound effect module 190 receives the piezoelectric signal, the piezoelectric signal may be converted to the aftertouch effect by an audio function program. In particular, every one of the electrode units 162 may respectively produce the piezoelectric signal, and convert the piezoelectric signal to individual aftertouch effect by the touch-activated sound effect module 190, since the conductive regions 144 of the conductive film 140 respectively corresponds to each electrode unit 162.

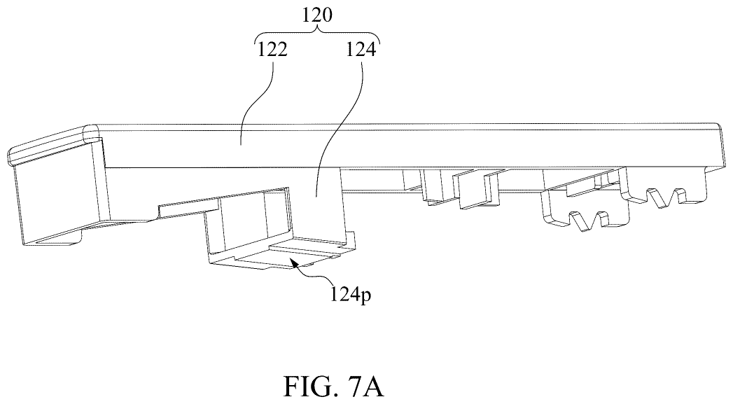

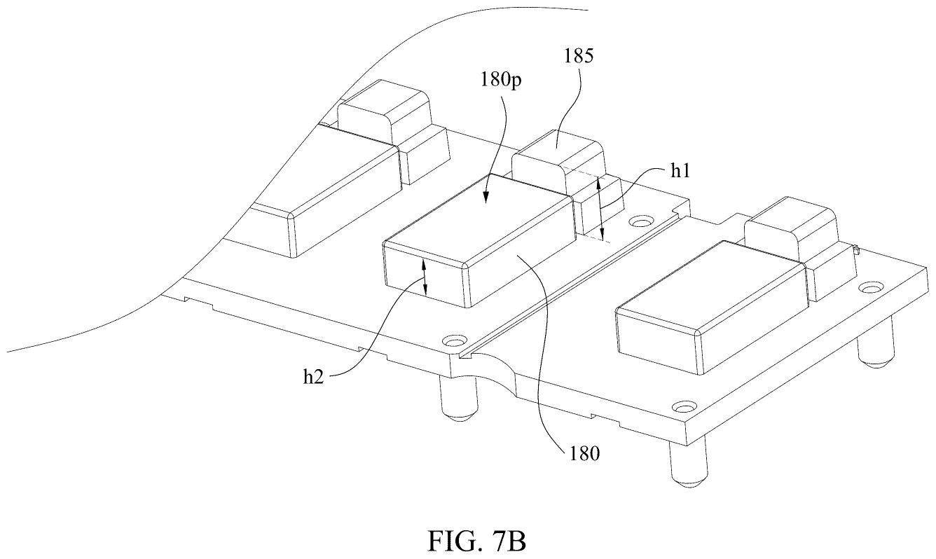

FIGS. 7A and 7B illustrate the partial stereograms of the electronic keyboard module 100 of at least one example of the present disclosure, in which FIG. 7A includes the keys 122 and the key height-limited posts 124, and FIG. 7A includes the elastic bodies 180. As shown in FIG. 7A, every one of the key height-limited posts 124 has the plane 124p, and the plane 124p faces toward the conductive film 140. The area of the plane 124p is greater than or equal to the area of the conductive regions 144. On the other hand, as shown in FIG. 7B, every one of the elastic bodies 180 has the plane 180p in the example including the elastic bodies 180. The plane 180p faces toward the conductive film 170, and the area of the plane 180p is greater than or equal to the area of the conductive regions 144.

Therefore, when one of the keys 122 is in the pressed state, the plane 124p of the key height-limited posts 124 is substantially aligned with the top of the conductive region 144 of the conductive film 140, and the plane 180p of the elastic bodies 180 is also substantially aligned with the top of the conductive region of the conductive film, enabling the key height-limited posts 124 may evenly apply the force to all the range of the conductive region 144 after being pressed down. However, the present disclosure is not limited to the above. In various examples, the area of the plane 124p of the key height-limited posts 124 may be less than the area of the conductive region 144, and the area of the plane 180p of the elastic bodies 180 may be less than the area of the conductive region 144.

In addition, back to FIG. 4, the insulation layer 142 may further includes the plural positioning grooves 142c, and the positioning grooves 142c are disposed one-to-one between the keys 122 of the keyboard 120 and the electrode units 162 of the force sensing resistor circuit board 160. Jointly refer to FIG. 2, in which the lower surface 142f of the insulation layer 142 faces toward the force sensing resistor circuit board 160. The opening OP1 of every one of the positioning grooves 142c faces toward the force sensing resistor circuit board 160, and the conductive regions 144 are disposed one-to-one on the bottom surface BS1 of every one of the positioning grooves 142c. In particular, the spacing d1 between the opening OP1 of the positioning grooves 142c and the bottom surface BS1 have to be greater than the thickness of the conductive regions 144 (no labeled) to prevent the conductive regions 144 from being in contact with the electrode units 162 without applying the force to and deforming the conductive film 140. For example, the thickness of the conductive regions 144 is in the range of 0.01 mm to 0.04 mm, and the spacing d1 of the opening OP1 of the positioning grooves 142c and the bottom surface BS1 is in the range of 0.06 mm and 0.07 mm.

Referring to FIG. 7B, the electronic keyboard module 100 further includes the positioning elastic post 185. The positioning elastic post 185 is disposed at intervals on the elastic bodies 180, and the height h1 of the positioning elastic post 185 is greater than the height h2 of elastic bodies 180. Therefore, the key height-limited posts 124 are in contact with the positioning elastic post 185 in the pressed state. In detail, when the key height-limited posts 124 is pressed down, the key height-limited posts 124 may be first in contact with the positioning elastic post 185, thereby temporally pressing against the key height-limited posts 124. However, when the pressed state continues, and the force applied to the positioning elastic post 185 by the key height-limited posts 124 gradually increases, the key height-limited posts 124 continues pressing to be in contact with the elastic bodies 180.

Based on the above, since the conductive regions of the conductive film of the electronic keyboard are disposed one-to-one under the key height-limited posts, therefore, when the keys are in the pressed state, the keys may drive the key height-limited posts downward to be in contact with the conductive film, and push the conductive regions distributed in the conductive film toward the force sensing resistor circuit board, so that the conductive regions may be electrically connected to the electrode units which is on the force sensing resistor circuit board. Since one key corresponds to one conductive region and one electrode unit, the keys may respectively produce independent aftertouch effects to improve the expressive richness of playing. On the other hand, the areas of the key height-limited posts that are contact with the conductive regions (through the elastic bodies) are substantially the same. Therefore, the contact force between the conductive regions and the electrode units may be evenly distributed, thereby improving the stability of the aftertouch effect.

Although the present disclosure has been disclosed as above by the examples, it is not intended to limit the present disclosure, and those skilled in the art may make some changes and embellishments without departing from the spirit and scope of the present disclosure, and therefore the scope of protection of the present disclosure shall be determined by the scope of the attached patent application.

What is claimed is:

1. An electronic keyboard module, comprising:
a keyboard bracket;
a keyboard located at the keyboard bracket and comprising:
a plurality of keys; and
a plurality of key height-limited posts disposed one-to-one on lower surfaces of the keys;
a conductive film located under the keyboard and comprising:
an insulation layer under the key height-limited posts; and
a plurality of conductive regions spaced apart from each other on the insulation layer, and disposed one-to-one under the keys, wherein the insulation layer is between the key height-limited posts and the conductive regions; and
a force sensing resistor circuit board disposed under the conductive film, wherein the conductive film is between the keyboard and the force sensing resistor circuit board, wherein the force sensing resistor circuit board comprises:
a plurality of electrode units disposed one-to-one under the conductive regions of the conductive film;
wherein when at least one of the keys is in a pressed state, the key height-limited posts under at least the one of the keys touch the conductive film, enabling the conductive regions corresponding to at least the one of the keys to touch and be electrically connected to the corresponding electrode units.

2. The electronic keyboard module of claim 1, further comprising:
a touch-activated sound effect module electrically connected to the force sensing resistor circuit board and configured to receive a piezoelectric signal from the force sensing resistor circuit board;
wherein when the conductive regions touch and are electrically connected to the corresponding electrode units, the force sensing resistor circuit board outputs the piezoelectric signal.

3. The electronic keyboard module of claim 1, wherein every one of the key height-limited posts has a plane, and the plane faces toward the conductive film, wherein an area of the plane is greater than or equal to an area of every one of the conductive regions.

4. The electronic keyboard module of claim 1, wherein a thickness of the conductive regions is in a range of 0.01 mm to 0.04 mm.

5. The electronic keyboard module of claim 1, wherein the insulation layer is a polyester film.

6. The electronic keyboard module of claim 1, wherein the insulation layer comprises:
a plurality of positioning grooves disposed one-to-one between the electrode units and the keys, wherein an opening of every one of the positioning grooves faces toward the force sensing resistor circuit board, and the conductive regions are disposed one-to-one on a bottom surface of every one of the positioning grooves.

7. The electronic keyboard module of claim 6, wherein spacing between the opening and the bottom surface of every one of the positioning grooves is greater than a thickness of the conductive regions.

8. The electronic keyboard module of claim 7, wherein the spacing between the opening and the bottom surface of every one of the positioning grooves is in a range of 0.06 mm and 0.07 mm.

9. The electronic keyboard module of claim 1, further comprising:
a plurality of elastic bodies disposed one-to-one under the key height-limited posts, and between the key height-limited posts and the conductive film, wherein when at least the one of the keys is in the pressed state, the key height-limited posts under at least the one of the keys touch the conductive film, enabling the conductive regions corresponding to at least the one of the keys to touch and be electrically connected to the corresponding electrode units.

10. The electronic keyboard module of claim 9, wherein the pressed state are maintained from an initial time to a complete time, and a contact area of one of the elastic bodies and one of the electrode units is gradually increased between the initial time and the complete time.

11. The electronic keyboard module of claim 9, wherein every one of the elastic bodies has a plane, and the plane faces toward the conductive film, wherein an area of the plane is greater than or equal to an area of every one of the conductive regions.

12. The electronic keyboard module of claim 9, further comprising:
a positioning elastic post disposed at intervals on the elastic bodies, and a height of the positioning elastic post is greater than a height of elastic bodies, wherein the key height-limited posts touch the positioning elastic post in the pressed state.

13. An electronic keyboard module, comprising:
a keyboard bracket;
a keyboard located at the keyboard bracket and comprising:
a plurality of keys, wherein each has one end connected to the keyboard bracket via a spring, and the other end extending out from the keyboard bracket; and
a plurality of key height-limited posts disposed one-to-one on lower surfaces of the keys;
a conductive film located under the keyboard and comprising:
an insulation layer under the key height-limited posts; and
a plurality of conductive regions spaced apart from each other on the insulation layer, and disposed one-to-one under the keys, wherein the insulation layer is between the key height-limited posts and the conductive regions; and
a force sensing resistor circuit board disposed under the conductive film, wherein the conductive film is between the keyboard and the force sensing resistor circuit board, wherein the force sensing resistor circuit board comprises:
a plurality of electrode units disposed one-to-one under the conductive regions of the conductive film;
wherein when at least one of the keys is in a pressed state, the key height-limited posts under at least the one of the keys touch the conductive film to make the conductive regions corresponding to at least the one of the keys touch and be electrically connected to the corresponding electrode units.

14. The electronic keyboard module of claim 13, wherein a plane of the key height-limited posts is substantially aligned with a top of the conductive region of the conductive film when one of the keys is in the pressed state.

15. The electronic keyboard module of claim 14, further comprising:
a plurality of elastic bodies, wherein a plane of the elastic bodies is substantially aligned with the top of the conductive region of the conductive film when the one of the keys is in the pressed state.
